(19) United States
(12) Patent Application Publication
(10) Pub. No.: US 2017/0183245 A1
(43) Pub. Date: Jun. 29, 2017

(54) ELECTROCOAGULATION DEVICES AND METHODS

(71) Applicant: Cameron International Corporation, Houston, TX (US)

(72) Inventors: Jonathan K. Powell, Cypress, TX (US); Jason L. Pitcher, The Woodlands, TX (US)

(21) Appl. No.: 15/389,965

(22) Filed: Dec. 23, 2016

Related U.S. Application Data
(60) Provisional application No. 62/272,235, filed on Dec. 29, 2015.

(51) Int. Cl. C02F 1/463; C02F 1/461; C25B 9/06

(52) U.S. Cl. CPC C02F 1/463; C25B 9/06; C02F 1/46109; C02F 2103/10

(57) ABSTRACT

Various electrocoagulation devices for treating liquids are provided. In one embodiment, an apparatus includes an electrocoagulation device having a pressure-containing vessel for receiving a liquid, with a first bus bar, a second bus bar, and sacrificial plates positioned in the pressure-containing vessel. The plates are positioned so as to create a winding flow path for the liquid through the pressure-containing vessel. The plates include first and second subsets of sacrificial plates, and each sacrificial plate can include an outer perimeter having a larger recess and a smaller recess. The smaller recess enables electrical contact with one of the two bus bars, while the larger recess allows receipt of the other of the two bus bars without electrical contact. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources. Particularly, once a desired subterranean resource is discovered, drilling and production systems are often employed to access and extract the resource. These systems may be located onshore or offshore depending on the location of a desired resource. Further, such systems generally include a wellhead assembly through which the resource is extracted.

In some instances, such wellhead assemblies may use a fracturing tree and other components to facilitate a fracturing process and stimulate production from a well. As will be appreciated, resources such as oil and natural gas are generally extracted from fissures or other cavities formed in various subterranean rock formations or strata. To facilitate extraction of such resources, a well may be subjected to a fracturing process that creates one or more man-made fractures in a rock formation. This facilitates, for example, coupling of pre-existing fissures and cavities, allowing oil, gas, or the like to flow into the wellbore. Such fracturing processes typically include injecting a fracturing fluid—often a mixture or slurry including sand and water—into the well to increase the well's pressure and form the man-made fractures.

Fracturing fluid often includes water (or another liquid) mixed with sand or some other proppants. The fracturing fluid is pumped down a well into a formation to extend fractures and fill them with the proppants, which operate to hold open the fractures after pumping has stopped to allow formation fluids to be more easily produced via the well. Wastewater or other liquid waste flowing out of the well from a fracturing process may include various contaminants, such as heavy metals. This liquid waste can be treated in various ways to remove such contaminants. For example, electrocoagulation can be used to cause contaminants suspended in a waste liquid to precipitate, which facilitates removal of the contaminants from the liquid.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to electrocoagulation devices for treating wastewater or other fluids. In one embodiment, an electrocoagulation device includes sacrificial plates installed in a pressure-containing vessel. The plates can include exterior recesses that receive bus bars in the vessel and allow each plate to electrically contact one of the bus bars. A potential difference may be applied across the plates via the bus bars to create an electric field for electrocoagulation. In another embodiment, sacrificial plates are positioned on a support rod within a pressure-containing vessel, and these plates can also be charged to generate an electric field for treating a fluid via electrocoagulation.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts an apparatus for treating a contaminated fluid, the apparatus including an electrocoagulation device, in accordance with one embodiment of the present disclosure;

FIGS. 2 and 3 depict an electrocoagulation device having bus bars and reversible sacrificial plates with recesses for receiving bus bars installed in a pressure-containing vessel in accordance with one embodiment;

FIGS. 4 and 5 depict receipt of the bus bars in recesses of two sacrificial plates of the electrocoagulation device of FIGS. 2 and 3 in accordance with one embodiment;

FIG. 6 depicts an electrocoagulation device having sacrificial plates positioned along a support rod within a pressure-containing vessel in accordance with one embodiment;

FIG. 7 generally depicts multiple electrocoagulation devices connected in series to treat liquid in accordance with one embodiment; and

FIG. 8 generally depicts multiple electrocoagulation devices connected in parallel to treat liquid in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

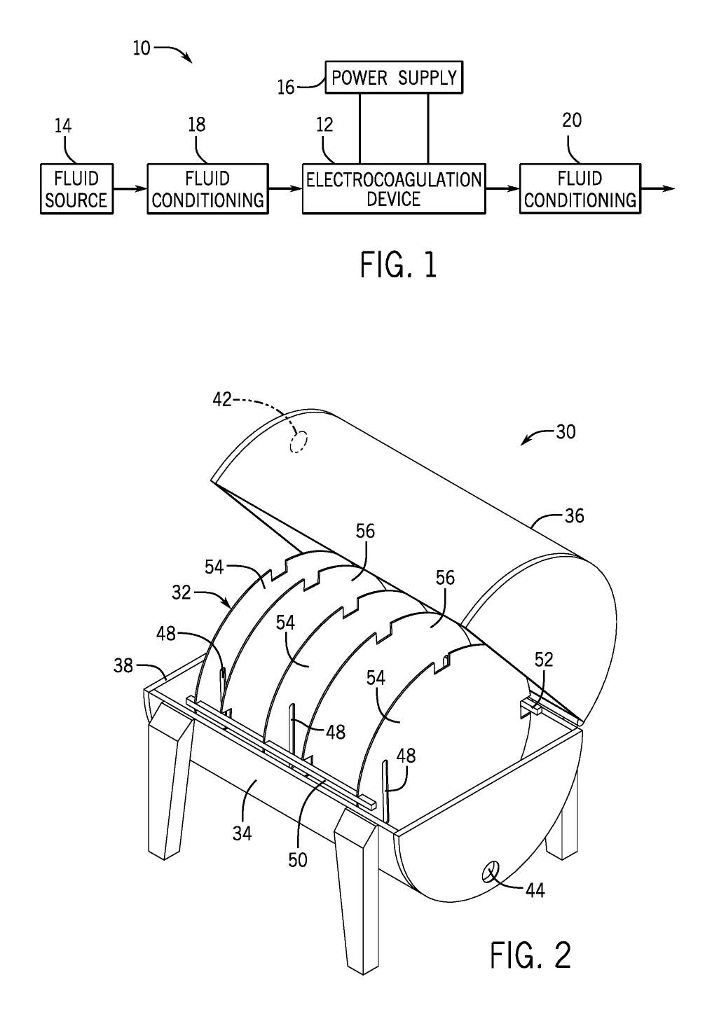

Turning now to the present figures, an example of an apparatus 10 for treating water or other fluids is provided in FIG. 1 in accordance with one embodiment. The apparatus 10 can be used in the oil and gas industry to treat wastewater or other fluids from a well, such as flowback fluid from hydraulic fracturing or produced water. It is noted, however, that the presently depicted apparatus 10 could be used to treat fluids in other industries and contexts.

The depicted apparatus 10 includes an electrocoagulation device 12 for removing contaminants from water or other fluid received from a fluid source 14 (e.g., a well). As described further below, the electrocoagulation device 12 uses electricity from a power source 16 (e.g., a direct current power source) to cause the agglomeration of contaminants in the treated fluid, which facilitates removal of the contaminants. For example, the larger collective size of the agglomerated contaminants can cause the contaminants to fall out of a treated liquid (e.g., through sedimentation) or to float to the top of the treated liquid. Further, these agglomerated contaminants resulting from coagulation within the device 12 may be more easily filtered from the treated liquid. Any suitable power source 16 could be used, such as a battery or a generator.

Various fluid conditioning devices or systems, which are here generally denoted with reference numerals 18 and 20, can be used for treating the fluid upstream and downstream of the electrocoagulation device 12. For example, the fluid conditioning devices 18 and 20 can include filters (or other solids-removal systems) upstream of the device 12 for removing contaminants or larger debris and filters downstream of the device 12 for removing contaminants that coagulate in the treated fluid within the device 12. As another example, a fluid conditioning device 20 downstream of the electrocoagulation device 12 could include a clarifier, in which treated water or other liquid is received and the coagulated contaminants are allowed to settle within a tank or float to the surface of the liquid in the tank to facilitate their removal. Still further, reagents or other chemicals can be added to the liquid to promote agglomeration of contaminants for easier removal. Such reagents or chemicals could be added to the liquid routed from the device 12 before the liquid enters a clarifier, for instance.

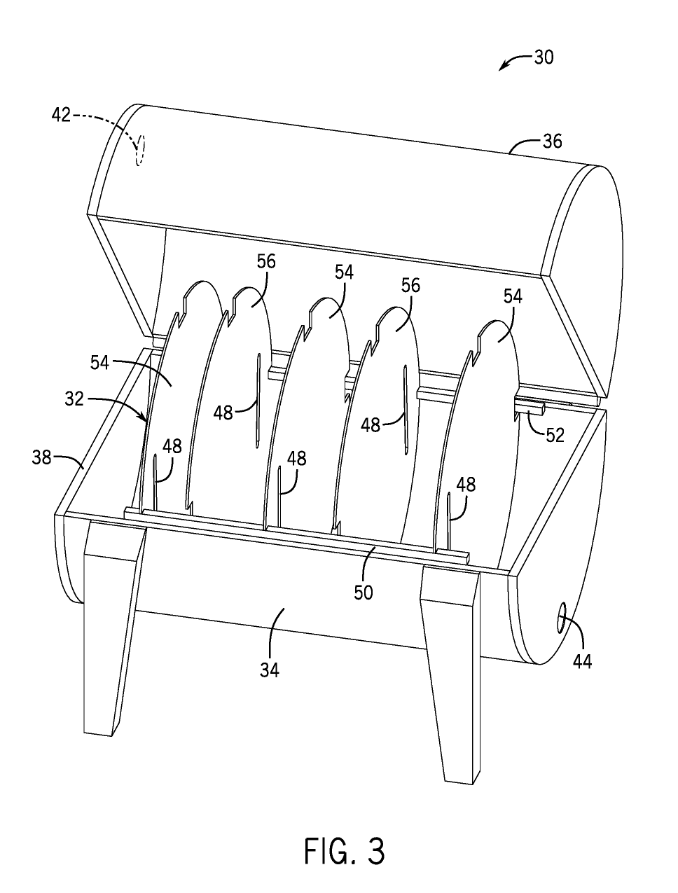

The electrocoagulation device 12 of the apparatus 10 may take many forms, one example of which is depicted in FIGS. 2 and 3 as an electrocoagulation device 30. The depicted device 30, which may also be referred to as an electrocoagulation reactor, includes a series of plates 32 within a pressure-containing vessel or housing 34. The plates 32 are sacrificial plates that can be electrically charged to apply a potential difference across the plates and cause coagulation of contaminants in a treated liquid (e.g., wastewater) flowing through the reactor 30. The plates 32 can be formed of any suitable material, such as iron or aluminum. Further, while just five plates 32 are shown in FIGS. 2 and 3 for the sake of explanation, in an actual application the device 30 could have twenty to forty plates or any other suitable number of plates.

The pressure-containing vessel 34 includes a hinged lid 36, which facilitates access to the interior cavity of the vessel 34 and installation of plates 32 within this cavity. The depicted vessel 34 includes a cylindrical interior cavity with round plates 32, but the plates 32 and the interior cavity of the vessel 34 could have other shapes in different embodiments. The vessel 34 can include a sealing surface 38 (e.g., a seal positioned along an edge of the vessel 34) to inhibit fluid leakage out of the interior cavity when the lid 36 is closed. Latches or any other suitable mechanism could be used to secure the lid 36 in its closed position during operation (e.g., when pressurized fluid is introduced into the vessel 34 for treatment). Wastewater or other liquid to be treated can be introduced into the vessel 34 via an inlet 42, routed past the plates 32, and then discharged from an outlet 44.

The plates 32 include apertures 48 that allow passage of the treated liquid from the inlet 42 to the outlet 44 through the plates 32. As shown in FIG. 3, the aperture 48 for each successive plate 32 may be positioned at a different radial location than that of the previous plate 32 to provide a winding flow path for the liquid routed through the electrocoagulation device 30. More specifically, in the presently depicted embodiment the plates 32 are arranged such that the radial positions of the apertures 48 alternate over the series of plates to create a switchback flow path through the device 30. This generally increases the distance traveled by treated liquid flowing through the series of apertures 48 through the plates 32, with the liquid passing transversely between each pair of plates 32 as it flows from the aperture 48 of one plate to that of the other. In at least some embodiments, the primary flow path of the treated liquid through the device 30 is from the inlet 42 and through the aperture 48 of each successive plate 32 (i.e., moving left to right in FIG. 3) to the outlet 44, though some of the treated liquid may pass between the circumferential perimeter of the plates 32 and the interior surface of the vessel 34.

The electrocoagulation device 30 also includes bus bars 50 and 52 in electrical communication with at least some of the plates 32. More specifically, in the presently depicted embodiment a first subset of the plates is in electrical communication with the bus bar 50, while a second subset of the plates is in electrical communication with the bus bar 52. For ease of reference, the plates of the first subset (in contact with the bus bar 50) are denoted as plates 54 in FIGS. 2 and 3, while the plates of the second subset (in contact with the bus bar 52) are denoted as plates 56.

The bus bars 50 and 52 can be coupled in electrical communication with the power supply 16 in any suitable manner (e.g., via electrical leads extending through the wall of the vessel 34). Further, the bus bars 50 and 52 in at least some embodiments are formed from a non-sacrificial material or include isolation sleeves that inhibit contact between the bars 50 and 52 and the treated liquid. It will be appreciated that such isolation sleeves could include apertures or slots to facilitate contact with plates that are to be charged via the bus bars. A voltage differential applied to the bus bars 50 and 52 creates an electric field between the plates, which function as anodes and cathodes during electrocoagulation treatment of liquid passing through the electric field between the plates. This electric field facilitates agglomeration of contaminants in the treated liquid flowing through the device 30, as generally described above.

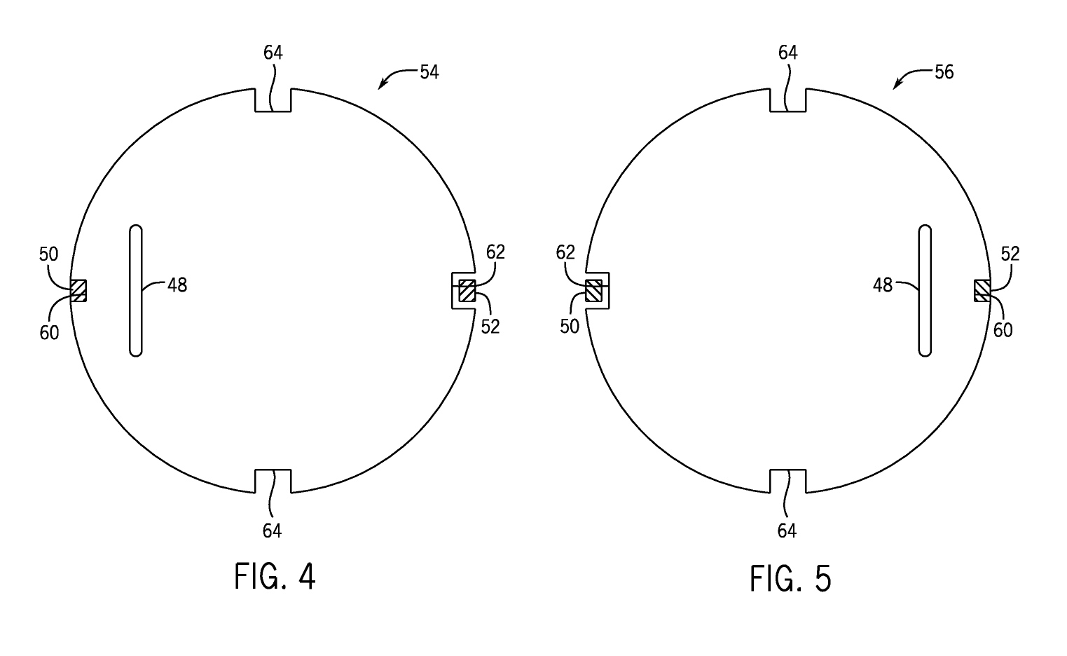

The bus bars 50 and 52 are shown in FIGS. 2 and 3 as extending along the interior of the vessel 34 near the plates 54 and 56. These plates 54 and 56 include recesses in their outer perimeters that facilitate contact with one of the bus bars 50 or 52, while avoiding contact with the other bus bar. These recesses, as well as the positions of the bus bars 50 and 52 with respect to these recesses, may be better appreciated with reference to FIGS. 4 and 5.

As shown in FIGS. 4 and 5, both plates 54 and 56 include a smaller recess 60 that receives one of the bus bars 50 or 52, and a larger recess 62 on an opposite end of the plate that receives the other bus bar. The smaller recess 60 is sized so as to contact the bus bar 50 or 52 received in this recess when installed in the vessel 34, while the larger recess 62 is sized to avoid contacting the bus bar 50 or 52 received in that recess. Consequently, though these recesses 60 and 62 allow passage of both bus bars 50 and 52 along opposite ends of the plates inside the electrocoagulation reactor vessel 34, the plates 54 are in electrical contact with bus bar 50 (and not bus bar 52), while the plates 56 are in electrical contact with the bus bar 52 (and not bus bar 50).

From the above, it will be appreciated that installing the plates 54 in the vessel 34 can include orienting the plates 54 inside the vessel 34 to receive and contact the bus bar 50 in their recesses 60, and to receive the bus bar 52 in their recesses 62 without making electrical contact between the plates 54 and the bus bar 52. Likewise, installing the plates 56 in this embodiment includes orienting the plates 56 inside the vessel 34 to receive and contact the bus bar 52 in their recesses 60 (placing the plates 56 in electrical communication with the bus bar 52), and to receive the bus bar 50 in their recesses 62 without making electrical contact between the plates 56 and the bus bar 50.

In at least some embodiments, including that depicted in FIGS. 2-5, the plates 54 and 56 are identical in size and exterior profile or shape. This allows one plate 32 to serve as either a plate 54 or a plate 56 based on its orientation in the vessel 34. For example, the plate 54 depicted in FIG. 4 could be reoriented before installation inside the vessel 34, such as by rotating the plate one hundred eighty degrees about a central axis perpendicular to the plate, to instead serve as a plate 56. In the present embodiment having bus bars 50 and 52 on opposite sides within the vessel 34, the plates 32 are reversible plates. That is, a plate 54 can be turned over about a vertical axis (e.g., through additional recesses 64 and the center of the plate ion FIG. 4) to instead be installed as a plate 56.

The plates 54 and 56 are shown in FIGS. 4 and 5 as each having two additional recesses 64 that are larger than the smaller recess 60 (e.g., the recesses 64 may be the same size as the recesses 62). These additional recesses 64 are provided opposite one another between the recesses 60 and 62. In the presently depicted embodiment, the recesses 64 are provided one hundred eighty degrees apart from one another about the circumference of round plates 54 and 56, and ninety degrees apart from each recess 60 and 62. The recesses 64 could be positioned differently in other embodiments, however. The recesses 64 are sized to avoid contact with the bus bars 50 and 52 when the plates 54 and 56 are rotated from the positions shown in FIGS. 4 and 5 (e.g., a ninety degree rotation) such that the bus bars 50 and 52 are received in the recesses 64, rather than in the recesses 60 and 62. As such, the presence of the recesses 64 allow a given plate 32 to be installed in the vessel 34 as an inactive plate, with the bus bars 50 and 52 extending through the recesses 64 without making electrical contact with that plate.

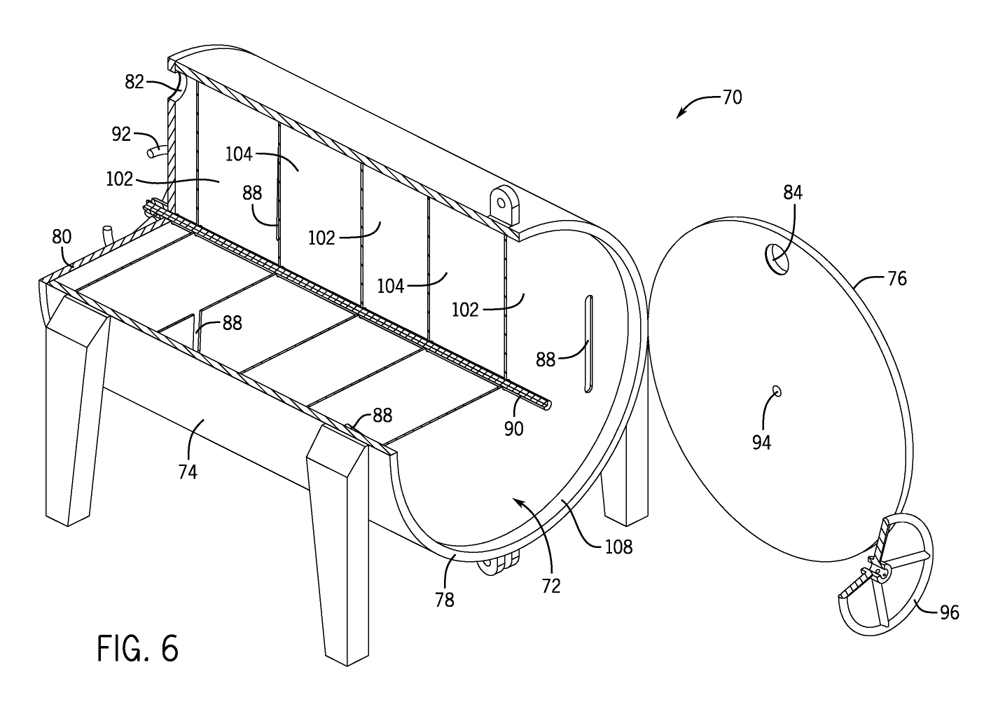

In accordance with another embodiment, an electrocoagulation reactor or device 70 is depicted in FIG. 6. This electrocoagulation device 70 includes sacrificial plates 72 installed in a pressure-containing housing or vessel 74. Like noted above with respect to the device 30, the device 70 is currently depicted as having round plates 72 positioned in a cylindrical cavity of the vessel 74, but these components could be shaped differently in other embodiments. Similarly, the device 70 can include any desired number of plates 72 within the vessel 74.

The depicted vessel 74 includes an access door 76 (e.g., a hinged door) on one end to allow installation and removal of the plates 72 inside the vessel 74. A sealing surface 78 inhibits leakage from the vessel 74 when the access door 76 is closed. The opposite end 80 of the vessel 74 can be provided as a wall (e.g., welded to the cylindrical body of the vessel 74) or as another access door. Wastewater or other liquid to be treated can be routed into the device 70 via an inlet 82, through the device 70 past the plates 72 (e.g., via slots or other apertures 88 in the plates), and then out of the device 70 via an outlet 84. The plates 72 are arranged to create a winding flow path between the plates 72 and through the apertures 88 for fluid treated in the electrocoagulation device 70.

The plates 72 are positioned on a support rod 90 extending through the vessel 74 from the opposite end 80. As shown in FIG. 6, the support rod 90 extends through apertures in the plates 72 and through the end 80 of the vessel 74, with a handwheel 92 attached at the end of the support rod 90. The apertures of plates 72 through which the support rod 90 extends are depicted here as being in the centers of the plates 72, though other configurations could be used in different embodiments. When the access door 76 is closed, the other end of the support rod 90 extends through the access door 76 via an aperture 94. A handwheel 96 can be attached to the end of the support rod 90 protruding out from the vessel 74 through the aperture 94. In at least some instances, the handwheels 92 and 96 (or some other form of handles) are threaded onto the support rod 90 and these threaded connections can be tightened to secure the access door 76 in sealing engagement with the sealing surface 78.

As discussed above with respect to electrocoagulation device 30, a differential voltage may be applied across the plates 72 to create an electric field in the vessel 74 that facilitates coagulation of contaminants in fluids treated in the device 70. For instance, a positive charge can be applied to one subset of the plates 72 (e.g., plates 102) and a negative charge can be applied to another subset of the plates 72 (e.g., plates 104). In some instances, the vessel 74 includes bus bars 50 and 52 in electrical communication with the plates 102 and 104, which can have recesses like those described above for plates 54 and 56 so that the plates 102 and 104 can contact one or the other of the bus bars 50 and 52 depending on their orientation. But in other embodiments, the plates 102 and 104 can be charged in some other manner. For instance, separate electrical leads to each of the plates 102 and 104 can be provided through the cylindrical wall 108 of the vessel 74 to allow positive and negative charges to be applied to the plates. In another embodiment, a weld seam in the cylindrical wall 108 of the vessel 74 can be used to apply a charge to the plates (e.g., the plates 102). Still further, in one embodiment the support rod 90 is electrically conductive and used to apply a charge to some of the plates 72 (e.g., the plates 104). Additionally, the plates 102 and 104 of at least one embodiment are identical in size and shape, with the designation as a plate 102 or a plate 104 governed solely by the electric charge applied to the plate.

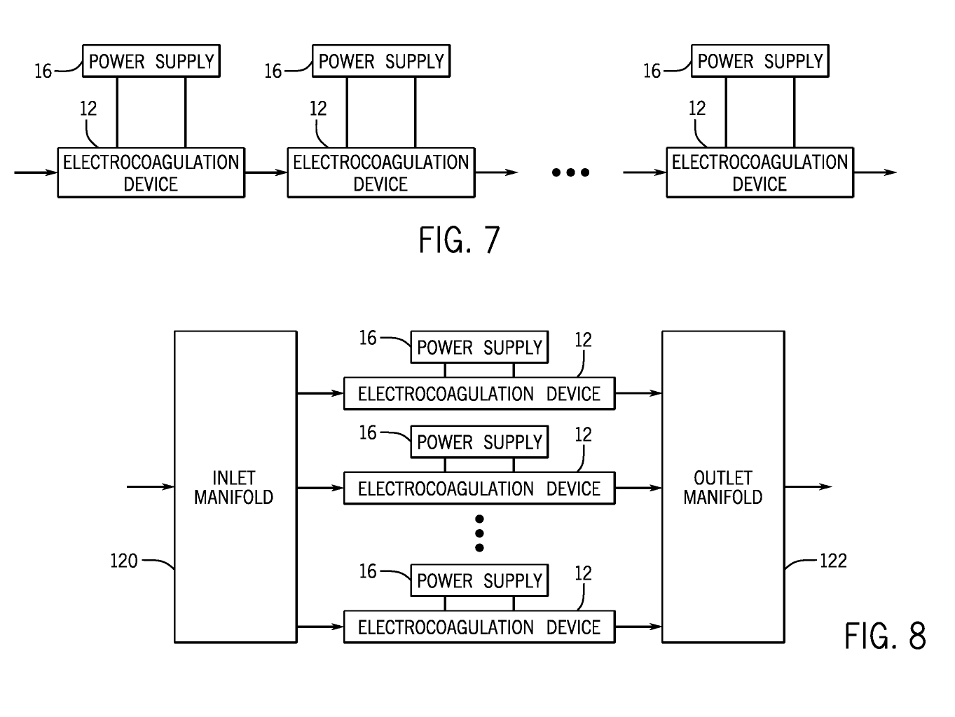

The effectiveness of the electrocoagulation devices described above may depend on numerous factors, including the flow rate of treated liquids through the devices, the contamination levels of the treated liquids, and various design parameters of the devices. In one instance, an electrocoagulation device described above can be used to treat liquid flowing through the device at a rate of four barrels per minute. Additional treatment capacity could be added by operating multiple electrocoagulation devices in series or in parallel. For example, as shown in FIG. 7, wastewater or other liquid to be treated could be passed through a series of electrocoagulation devices 12. Or, as shown in FIG. 8, treated liquid could be passed through multiple electrocoagulation devices 12 in parallel. For such parallel treatment, an inlet manifold 120 may be used to route liquid to the devices 12 and an outlet manifold 122 can receive the treated liquid from the devices 12 and route the liquid to downstream systems (e.g., a clarifier). The electrocoagulation devices of FIGS. 7 and 8 could include electrocoagulation reactors 30, electrocoagulation reactors 70, or a mix of both reactors 30 and 70. And while each electrocoagulation device 12 is depicted with its own power supply 16, it will be appreciated that a single power supply 16 could provide power to multiple electrocoagulation devices 12.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. An apparatus comprising:
an electrocoagulation device including:
a pressure-containing vessel for receiving a liquid;
first and second bus bars in the pressure-containing vessel; and
sacrificial plates positioned in the pressure-containing vessel to create a winding flow path for the liquid through the pressure-containing vessel, wherein the sacrificial plates include first and second subsets of sacrificial plates, and each sacrificial plate of the first and second subsets of sacrificial plates includes an outer perimeter having a larger recess and a smaller recess;
wherein the first bus bar is received in the smaller recesses of the sacrificial plates of the first subset and the larger recesses of the sacrificial plates of the second subset such that the first bus bar is in electrical contact with the sacrificial plates of the first subset but not with the sacrificial plates of the second subset, and the second bus bar is received in the smaller recesses of the sacrificial plates of the second subset and the larger recesses of the sacrificial plates of the first subset such that the second bus bar is in electrical contact with the sacrificial plates of the second subset but not with the sacrificial plates of the first subset.

2. The apparatus of claim 1, wherein the larger recess and the smaller recess are on opposite ends of each sacrificial plate of the first and second subsets.

3. The apparatus of claim 2, wherein the outer perimeter of each sacrificial plate of the first and second subsets of sacrificial plates includes two additional recesses larger than the smaller recess, and the two additional recesses are on opposite ends of each sacrificial plate between the larger recess and the smaller recess.

4. The apparatus of claim 2, wherein the sacrificial plates of the first and second subsets are identical in size and shape.

5. The apparatus of claim 1, wherein the outer perimeter of each sacrificial plate of the first and second subsets of sacrificial plates includes an additional recess larger than the smaller recess.

6. The apparatus of claim 1, wherein the pressure-containing vessel includes a hinged lid.

7. The apparatus of claim 1, wherein the pressure-containing vessel has a cylindrical interior cavity and the sacrificial plates are round plates positioned within the cylindrical interior cavity.

8. The apparatus of claim 1, comprising an additional electrocoagulation device coupled in series with the electrocoagulation device.

9. The apparatus of claim 8, wherein the additional electrocoagulation device includes: a pressure-containing vessel for receiving a liquid; a support rod in the pressure-containing vessel; and sacrificial plates positioned on the support rod within the pressure-containing vessel, wherein the support rod extends through apertures of the sacrificial plates.

10. The apparatus of claim 1, comprising an additional electrocoagulation device coupled in parallel with the electrocoagulation device.

11. An apparatus comprising:
an electrocoagulation device including:
a pressure-containing vessel for receiving a liquid;
a support rod in the pressure-containing vessel; and
sacrificial plates positioned on the support rod within the pressure-containing vessel, wherein the support rod extends through apertures of the sacrificial plates.

12. The apparatus of claim 11, wherein the pressure-containing vessel includes a cylindrical cavity in which the support rod and the sacrificial plates are positioned.

13. The apparatus of claim 11, wherein the apertures of the sacrificial plates through which the support rod extends are located at the centers of the sacrificial plates.

14. The apparatus of claim 11, wherein the sacrificial plates are round plates.

15. The apparatus of claim 11, wherein the pressure-containing vessel includes an access door and the support rod extends through an aperture of the access door.

16. The apparatus of claim 11, wherein the support rod extends through opposite ends of the pressure-containing vessel.

17. A method comprising:
providing sacrificial plates for an electrocoagulation device, each of the sacrificial plates including first and second recesses in its outer edge;
installing a first set of the sacrificial plates in a housing of the electrocoagulation device, wherein installing the first set of sacrificial plates includes orienting the first set of sacrificial plates to receive and contact a first bus bar in the first recesses of the first set of sacrificial plates and to receive but not contact a second bus bar in the second recesses of the first set of sacrificial plates; and
installing a second set of the sacrificial plates in the housing of the electrocoagulation device, wherein installing the second set of sacrificial plates includes orienting the second set of sacrificial plates to receive and contact the second bus bar in the first recesses of the second set of sacrificial plates and to receive but not contact the first bus bar in the second recesses of the second set of sacrificial plates.

18. The method of claim 17, wherein installing the first and second sets of the sacrificial plates in the housing includes positioning the first and second sets of the sacrificial plates along a support rod such that the support rod extends through apertures of the first and second sets of the sacrificial plates.

19. The method of claim 18, comprising:
closing a door of the housing to receive the support rod through an aperture in the door; and
threading a handle onto the support rod received through the aperture in the door to secure the door.

20. The method of claim 17, comprising treating water produced from a well in the electrocoagulation device.
